(19) United States
(12) Patent Application Publication
(10) Pub. No.: US 2009/0010483 A1
(43) Pub. Date: Jan. 8, 2009

(54) BLOCK-BASED LOSSLESS DATA HIDING IN THE DELTA DOMAIN

(75) Inventors: Oscar Chi Lim Au, Kowloon (HK); Shu Kei Yip, Kowloon (HK)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Kowloon (HK)

(21) Appl. No.: 11/772,536

(22) Filed: Jul. 2, 2007

(51) Int. Cl. G06K 9/00

(52) U.S. Cl. 382/100

(57) ABSTRACT

A system and methodology for encoding or decoding hidden data, such as a digital watermark, in raster media is provided in delta domain, a domain that creates a high-pass version of the raster media. Hidden data, such as a watermark, can be embedded in the general smooth region (low variance region) while a strong edge is preserved. A Mean-Square Error (MSE) reduction can be obtained by embedding the watermark in the delta domain. Using checkerboard-pattern watermark sequences and the delta domain, at least half of the total pixels in the image remain unchanged after watermark embedding. In order to recover the hidden data, some side information can be conveyed, in-band or out-of-band, to a decoder, such as various parameters used when performing the method. If protection from attacks, such as a JPEG encoding attack is desired, a location map can be provided to assist with hidden data recovery.

### TECHNICAL FIELD

The subject disclosure relates generally to data hiding in visual raster media, and more particularly to lossless encoding and decoding of hidden data, such as a digital watermark, in the delta domain.

### BACKGROUND OF THE INVENTION

Steganography is the art and science of writing hidden messages in such a way that no one apart from the intended recipient knows of the existence of the message. For example, digital watermarking is one application of steganography. Digital watermarking is one of the ways to prove the ownership and the authenticity of the media. In order to enhance the security of the hidden message, the hidden message should be perceptually transparent and robustness. However, for hidden messages, there is a tradeoff between the visual quality and the payload. The higher the payload is, the lower the visual quality is.

In traditional watermarking algorithms, a digital watermark signal is embedded into a digital host signal, such as an image, resulting in watermarked signal. However, distortion is introduced into a host image during the embedding process and results in Peak Signal-to-Noise Ratio (PSNR) loss. Although the distortion is normally small, some applications, such as medical and military, are sensitive to embedding distortion and may not tolerate permanent loss of signal fidelity. As a result, lossless data hiding, which can recover the original host signal and/or the hidden data signal perfectly after extraction, is desirable for at least these applications.

There are a number of existing lossless/reversible watermarking algorithms. In one algorithm, modulo operations are used to ensure the reversibility, however, it often results in “salt-and-peppers” artifacts. In another algorithm, a circular interpretation of bijective transform is used for lossless watermarking. Although the algorithm can withstand some degree of image encoding (e.g., JPEG) attack, “salt-and-peppers” artifacts are major disadvantages of the algorithm. In yet another algorithm, the prediction error between the predicted pixel value and the original pixel value to embed data is used; however, some overhead (e.g., a location map and a threshold values) is needed to ensure the reversibility.

The above-described deficiencies of current data hiding methods are merely intended to provide an overview of some of the problems of today's data hiding techniques, and are not intended to be exhaustive. Other problems with the state of the art may become further apparent upon review of the description of various non-limiting embodiments of the invention that follows.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

Encoding or decoding hidden data into raster media, such as an image or a video frame, is provided in delta domain, a domain that creates a high-pass version of the raster media. Hidden data, such as a watermark, can be embedded in the general smooth region (low variance region) while a strong edge is preserved. The Peak Signal-to-Noise Ratio (PSNR) between an image having hidden data and the original host image is high and there are no “salt-and-peppers” artifacts. A Mean-Square Error (MSE) reduction can be obtained by embedding a watermark in a delta domain. Using checkerboard-pattern watermark sequences and the delta domain, at least half of the total pixels in the image remain unchanged after watermark embedding. In order to recover the hidden data, some side information can be conveyed, in-band or out-of-band, to a decoder, such as various parameters used when performing the method. If protection from attacks, such as a JPEG encoding attack is desired, a location map can be provided to assist with hidden data recovery.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a schematic block diagram of an exemplary environment operable to encode/decode hidden data, as well as present the visual image, whether containing the hidden data or not, to a content consumer.

FIG. 2 illustrates an exemplary data flow while encoding a watermark according to one embodiment.

FIG. 3 illustrates example components of a hidden data encoder system according to one embodiment.

FIG. 4 illustrates an exemplary method of watermarking raster media according to one embodiment.

FIG. 5 illustrates an exemplary method of determining if block conditions are met and watermarking the block if the conditions are met.

FIGS. 6A-6B illustrate an example image to be encoded with hidden data and locations where hidden data encoding occurs.

FIG. 7 illustrates example components of a hidden data decoder system according to one embodiment.

FIG. 8 depicts how to determine what hidden data was encoded in an encoding location.

FIG. 9 illustrates an exemplary method for decoding hidden data hidden in raster media according to one embodiment.

FIG. 10 depicts the relationship between a minimum number of sub-blocks (Nₘᵢₙ) and the resulting payload and the peak signal to noise ratio (PSNR).

FIG. 11 depicts the effects of a JPEG attack on recovering the hidden data.

FIG. 12 is a block diagram representing an exemplary non-limiting computing system environment in which the present invention can be implemented.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g. hard disk, floppy disk, magnetic strips . . . ), optical disks (e.g., compact disk (CD), digital versatile disk (DVD) . . . smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). The term “apparatus” as used herein is intended to include any apparatus that perform the functionality, regardless of whether the primary purpose of the apparatus is the functionality. Thus, for example, the decoding functionality can be performed by specialized hardware or can be performed on various content presentation devices. Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

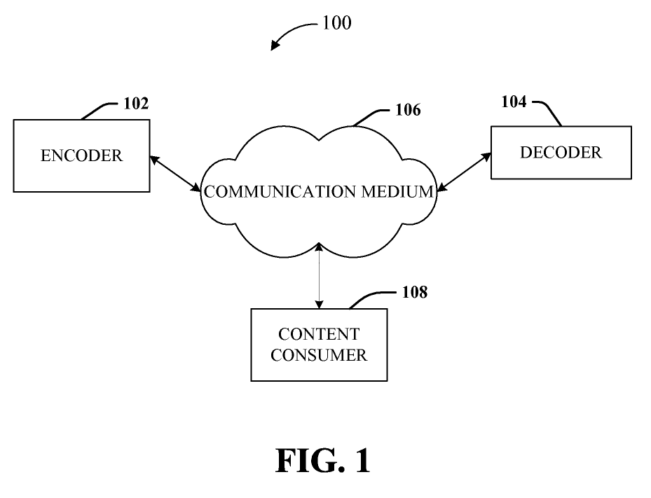

Referring now to FIG. 1, there is illustrated a schematic block diagram of an exemplary environment operable to present visual media, encode hidden data, and decode hidden data. For the sake of clarity, only a single system of each type is illustrated, but one skilled in the art will appreciate that there can be multiple computers of a given system type and that some of the system types can have their functionality distributed between two or more computing machines. Furthermore, one will appreciate that some or all of the types can, in some embodiments, be performed on a single computing machine.

The system 100 includes an encoder 102. The encoder 102 can be hardware and/or software (e.g., threads, processes, computing devices). The encoder inserts hidden data into rater media. In some embodiments, there are multiple encoders using different parameters. Selection of the appropriate encoder can be determined in some embodiments manually.

The system 100 also includes a decoder 104. The decoder 104 can also be hardware and/or software (e.g., threads, processes, computing devices). The decoder retrieves the hidden data and can also restore raster media with hidden data back to the original raster media. One possible communication between an encoder 102 and a decoder 104 can be in the form of data packets adapted to be transmitted between two or more computer processes. The data packets can include data representing visual raster media, such as a video frame or an image, as well as side information, such as encoding parameters or a location map, needed to decode the hidden data.

The system 100 also includes a content consumer 108. The content consumer can also be hardware and/or software (e.g., threads, processes, computing devices). The content consumer 108 presents the visual media to a user (directly or indirectly via a presentation device (not shown)) and/or stores the visual raster media for future distribution and/or playback. In some embodiments, the content consumer and/or its user is aware of the hidden data. For example, media companies may indicate that particular visual media is watermarked to deter unauthorized copying. In a second example, in at least one embodiment, the content presenter 108 and decoder 104 are executing on the same machine and that machine verifies authenticity before presenting the visual media to the user. In other embodiments, the content consumer 108 is unaware of the hidden data such as when the hidden data is not a digital watermark but instead a hidden message.

The system 100 includes a communication framework 106 (e.g. a global communication network such as the Internet; a computer-readable storage medium such as a tape, DVD, flash memory, hard drive, etc.; or the public switched telephone network) that can be employed to facilitate communications between the encoder 102, decoder 104 and content consumer 108. Communications can be facilitated via a wired (including optical fiber) and/or wireless technology and via a packet-switched or circuit-switched network. The communications can include one or more pieces of raster media encoded with hidden data and side information. Different communications can be performed via different communication means. For example, the side information can be transmitted by a computer-readable storage medium while the raster media can be transmitted over the Internet.

### Watermark Encoding

For the sake of simplicity and clarity, an embodiment involving a 256 shade grayscale image, and a digital watermark as hidden data are described as an exemplary embodiment. However, one will appreciate that the techniques may be applied to different raster media (e.g., a frame of video), multiple colors, multiple color depths, and different manners of performing delta transform. In addition, one will appreciate that the technique can be performed on a subset of the raster image rather than a whole image and that hidden data is not limited to a watermark.

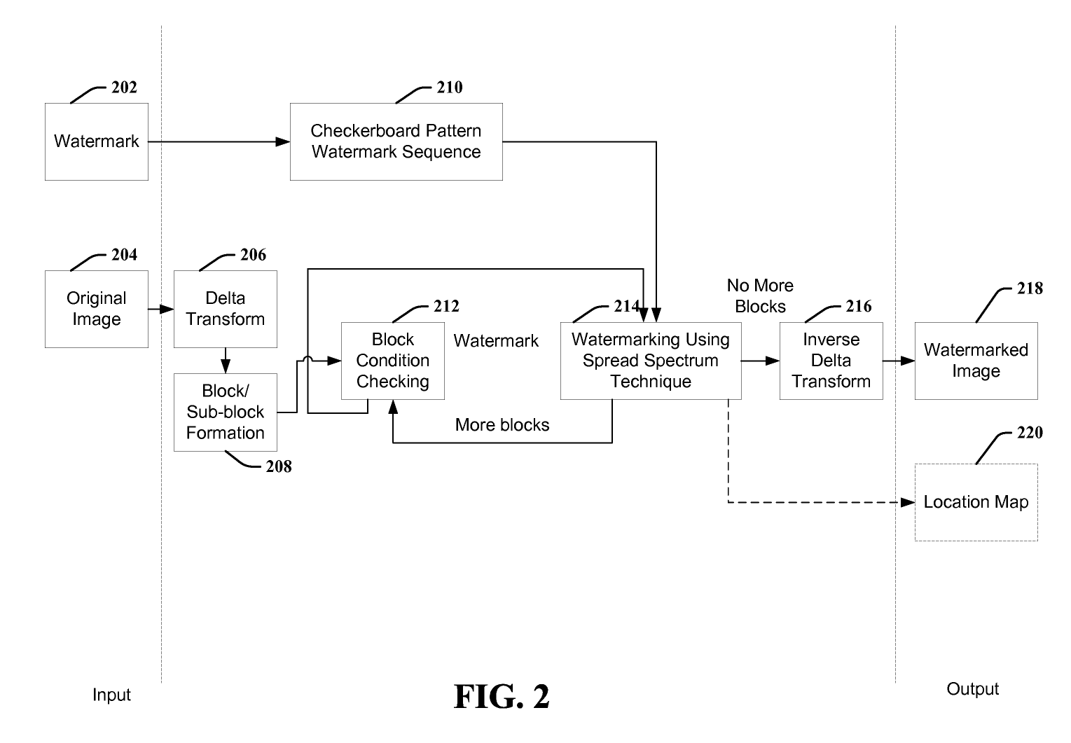

Referring to FIG. 2, a non-limiting exemplary embodiment is depicted. The original image 204 is denoted as P with a size of P_{X}×P_{Y}. P(x,y) is the pixel value of P at (x, y), where x=1 . . . P_{X} and y=1 . . . P_{Y}, P(x,y)ε{1 . . . 255}. A binary watermark, W, 202 is embedded into P to form a watermarked image, Q 218.

The delta domain can be thought of as a high-pass version of P. Vertical high-pass is used as an exemplary non-limiting method of performing delta domain transformation although in other embodiments other high pass versions can be used for delta transformation, such as a horizontal high pass. The delta domain of P, D, has the same size as P, and can be formed 206 by using the following delta transform equation for a vertical high-pass:

$$D ( x , y ) = \{ \begin{matrix}P ( x , y ) & if y = 1 \\ P ( x , y ) - P ( x , y - 1 ) & if y \geq 2\end{matrix} \qquad ( Equation 1 )$$

The first row of D, D(x, 1), is used to reconstruct the image from delta domain and to be a reference when performing inverse delta transform, and D(x, 1) is not used for data hiding. For y greater than 2, the larger the value of D is, the sharper the gradient change is in the spatial domain. By examining the value of D, the watermark can be embedded in a generally smooth region and still preserve the edge property of the image. One will appreciate that the image can be rotated so that a first column rather the first row is used to reconstruct the image in other embodiments.

After the formation of delta domain, D is divided into B_{X}×B_{Y} blocks (the first row is not used) during block/sub-block formation 208. The block set which is suitable for data hiding is denoted as SSet and the block set which is not suitable for data hiding is denoted as NSet. For each block, B, the block is further subdivided into sub-blocks, S, with the size of S_{X}×S_{Y}. S_{X} and S_{Y} should be an even number in order to achieve an MSE reduction.

To perform watermarking, a set of condition matrix, V_{C}, is used to check whether the blocks are qualified to be in SSet. By using a pair of watermark sequences with checkerboard-pattern and a spread spectrum watermarking technique, it is possible to embed the watermark into the digital image with MSE reduction. Block condition checking 212 is used to prevent “salt-and-peppers” artifacts and to ensure there are more than Nₘᵢₙ sub-blocks in a block which are “unbiased” to the watermark sequences pair before watermark embedding.

The inner product of A and B is denoted as <A, B>:

$$< A , B >= \frac{1}{NN} {\sum }_{i = 1}^{N} {\sum }_{j = 1}^{N} A ( i , j ) B ( i , j ) \qquad ( Equation 2 )$$

As part of the checkboard pattern watermark sequence 210 formation, watermark sequences and condition matrices are formed. For a binary watermark, if a watermark bit is “0”, a watermark sequence, W_{seq1}, is used. Similarly, if a watermark bit is “1”, a watermark sequence, W_{seq2} is used. There are three conditions for the watermark sequences pair (W1-3):

W1) W_{seq1} and W_{seq2} are complement pair.

W2) W_{seq1} and W_{seq2} are the same size as S.

W3) The “1”s and the “−1”s in the W_{seq1} and W_{seq2} are the same and are in a checkerboard-pattern.

More than one bit can be embedded in a block in other embodiments.

In the technique, there are N_{C} number of condition matrix, V_{C}, and there are mainly three conditions for V_{C} (R1-3):

R1) There are the same number of “1”s and “−1”s in each V_{C}.

R2) <W_{seq}, V_{C}>=0.

R3) Each V_{C} is orthogonal to each others, <V_{Ci}, V_{Cj}>=0 for i≠j.

Using 2×2 sub-block as an example, and N_{C} is set to 2, one of the possible set of V_{C}, V_{C1} and V_{C2} are:

$${V}_{C 1} = [ \begin{matrix}1 & 1 \\ - 1 & - 1\end{matrix} ]$$

$${V}_{C 2} = [ \begin{matrix}1 & - 1 \\ 1 & - 1\end{matrix} ]$$

and the pair of watermark sequences, W_{seq1} and W_{seq2}, are:

$${W}_{seq 1} = [ \begin{matrix}1 & - 1 \\ - 1 & 1\end{matrix} ]$$

$${W}_{seq 2} = [ \begin{matrix}- 1 & 1 \\ 1 & - 1\end{matrix} ]$$

After the formation of V_{C} and W_{seq}, block condition checking is followed. There are two conditions checking (C1-2) to check whether the block belongs to SSet:

C1) For all the sub-blocks, the corresponding average spatial intensity value, Int_{S}, should be within a predefined range.

C2) There should be more than Nₘᵢₙ sub-blocks which <S, V_{C}>≦T, where T is a predefined 2D region.

The constraint of (C1) is prevents “salt-and-peppers” artifacts. Constraint 2 is to look for the blocks which have more sub-blocks less correlated with W_{seq}, and to ensure there are more than Nₘᵢₙ sub-blocks in a block that are the “unbiased” sub-blocks to the W_{seq}. Moreover, (C2) is to ensure the sub-blocks are generally smooth region. For the blocks which do not belong to SSet, they are in NSet.

According to the watermark bit, W_{seq1} or W_{seq2} is watermarked to all sub-blocks in the block which belong to SSet using the following equation.

S′=S+ΔW_{seq} where seq={seq1,seq2} (Equation 3)

For the sub-blocks which belong to NSet:

s′=s (Equation 4)

S′ is the watermarked sub-block coefficients in delta domain and Δ is the watermark strength and should be an integer for ensuring reversibility. If the block is in NSet, it means there is a strong edge across many sub-blocks or the block has a high texture property so that the block is not suitable to embed watermark in order to preserve the edge property. The watermarked image, Q, 218 is formed by performing watermark embedding 214 using Equation 3 or Equation 4 in delta domain followed by the inverse delta transform 216 to restore the pixels. The inverse delta transform is shown as follows:

$$Q ( x , y ) = \{ \begin{matrix}D ( x , y ) & if y = 1 \\ Q ( x , y - 1 ) + {D}^{′} ( x , y ) & if y \geq 2\end{matrix} \qquad ( Equation 5 )$$

Although not shown, additional processing can occur in some embodiments. For example, original raster media can be transformed back to pixel values before processing, such as by transforming wavelet coefficients back to pixel values. In addition, a location map 220 can be produced in some embodiments to prevent attacks from making the watermark undetectable in the watermarked image.

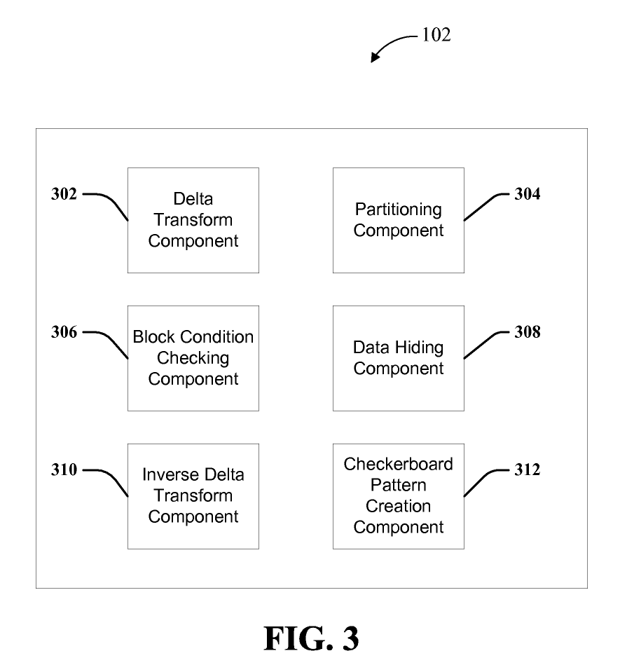

Referring to FIG. 3, an encoder 102 is illustrated with exemplary non-limiting components. The illustrated encoder 102 has a delta transform component 302, a partitioning component 304, a block condition checking component 306, a data hiding component 308, an inverse delta transform component 310, and a checkerboard pattern creation component 312.

The delta transform component 302 transforms the raster media into delta domain coefficients. Conversely, the inverse delta transform component transforms delta domain coefficients back to pixel values. The partitioning component 304 partitions the raster media into blocks and sub-blocks. The block condition checking component 306 checks whether a block meets condition C1 and condition C2 for encoding. The data hiding component 308 encodes the hidden data (e.g. watermark). The checkerboard pattern creation component 312 creates valid watermark sequences and conditional matrices.

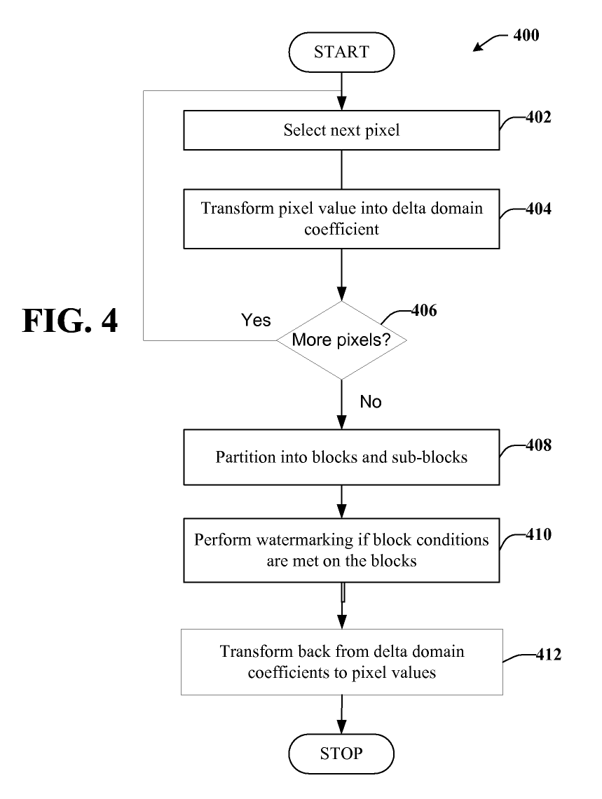

FIGS. 4, 5 and 9 illustrate various methodologies in accordance with one embodiment. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media. Furthermore, it should be appreciated that although for the sake of simplicity an exemplary method is shown for use with a single color value for a pixel, the method can be performed for multiple color values.

Referring to FIG. 4, an exemplary method of encoding a watermark is illustrated. At 402, the next pixel is selected or the first pixel if no pixels have been processed yet. At 404, the pixel is transformed into delta domain coefficients. At 406, if there are more pixels, the method proceeds to 402. Acts 402-406 perform delta domain transform. In some embodiments, a subset of pixels are transformed and potentially used for watermark encoding, such as for large images and small watermarks. At 408, the resulting raster media coefficients are portioned into blocks and sub-blocks. At 410, watermarking is performed if block conditions are met on the blocks. At 412, the delta domain coefficients are transformed back into pixel values. The resulting encoded raster media can then be transmitted to content consumers or decoders. Alternatively, the delta domain coefficients can be transmitted and the inverse transformation can be performed by the content consumer or the decoder.

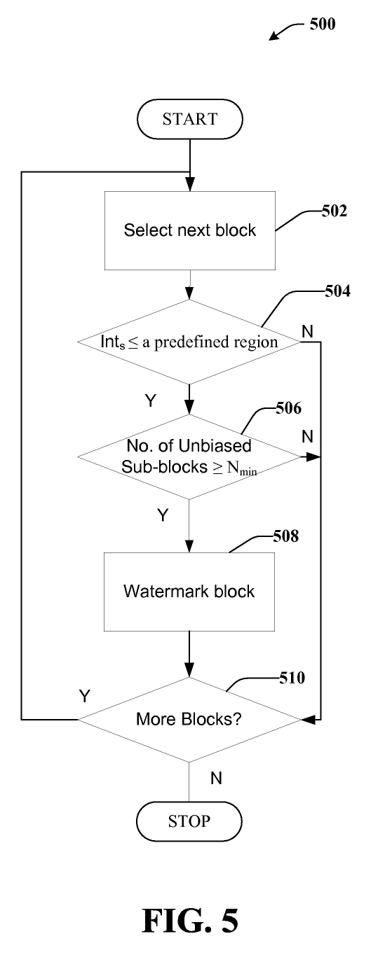

Referring to FIG. 5, an exemplary method of determining if block conditions are met is illustrated. A similar method is performed for block checking when extracting the hidden data. The method can be performed, for example, during 410 of FIG. 4 and performed as part of the block condition checking component 306 of FIG. 3. At 502, the next block is selected—including the first block if no other blocks have been processed. At 504, it is determined if a predefined region is greater than Int_{S}. If not, flow moves to 510 and if so, the method moves to 506. At 506, it is determined if the number of unbiased sub-blocks is greater than Nₘᵢₙ. Nₘᵢₙ is one of the parameters to ensure reversibility. In some embodiments, a user tunes Nₘᵢₙ iteratively to find out the minimum Nₘᵢₙ, NGₘᵢₙ, in the encoding process to ensure the reversibility. The maximum value of Nₘᵢₙ, NMₘᵢₙ, is equal to floor(B_{X}/S_{X})×floor(B_{Y}/S_{Y}). Thus, a user can choose any value between NGₘᵢₙ and NMₘᵢₙ for Nₘᵢₙ and the security of the hidden data is enhanced. In other embodiments, Nₘᵢₙ is automatically set, such as set to NGₘᵢₙ. If the number of unbiased sub-blocks is greater than Nₘᵢₙ, the method proceeds to 508 and if not, the method proceeds to 510. At 508, a watermark is encoded, such as via using a spread spectrum technique. At 510, it is determined if there are more blocks to process and if so, flow returns to 502 and if not, the method ends.

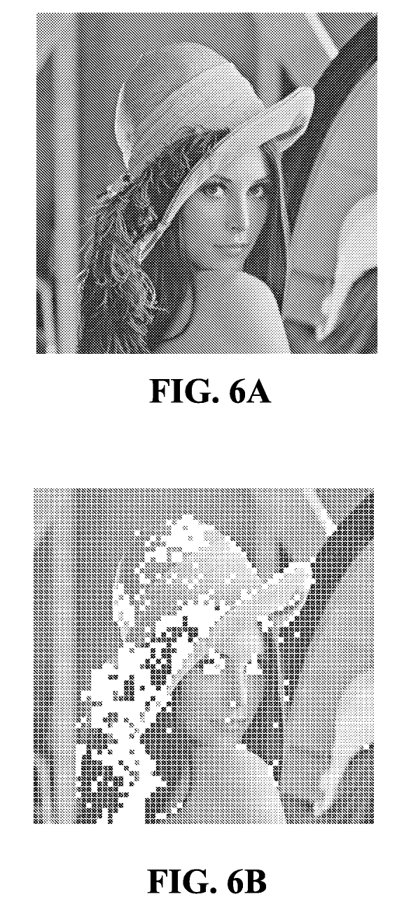

Referring to FIG. 6A, standard image Lena available from the USC-SIPI image database is illustrated as an example original image for encoding hidden data. The embedding locations for Lena are illustrated in FIG. 6B. The white blocks mean the blocks belong to NSet, and the other blocks belong to SSet. The described technique will mainly choose the blocks with low variance (e.g., in a smooth region). For the blocks with 45° edge or highly texture properties, those blocks will not be used for data hiding.

### Watermark Extraction

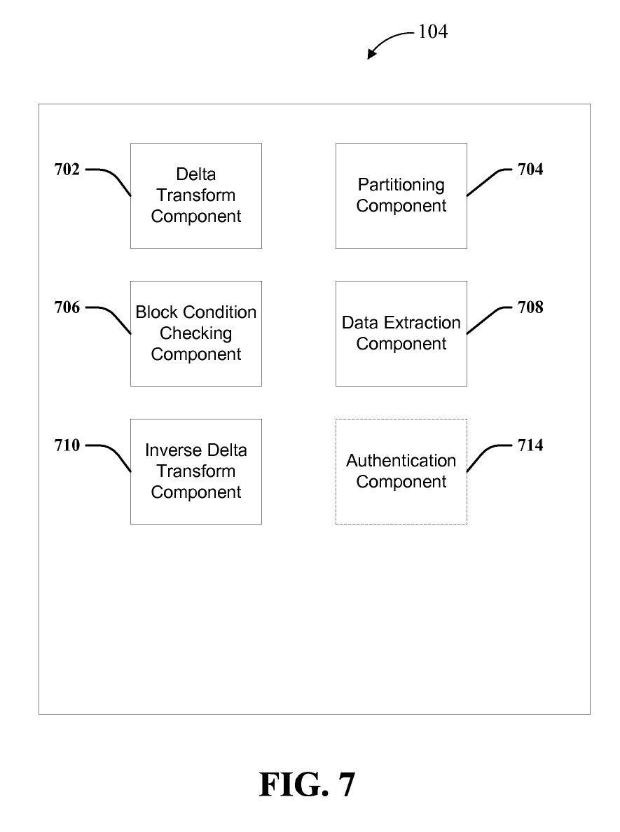

Referring to FIG. 7, exemplary components of a non-limiting decoder 104 are illustrated. The illustrated components include a delta transform component 702, a partitioning component 704, a block condition checking component 706, a data extraction component 708, an inverse delta transform component 710, and optionally an authentication component 714.

The delta transform component 702 transforms the raster image into the delta domain coefficients. Conversely, the inverse delta domain transform component 710 transforms delta domain coefficients back to pixel values. The partitioning component 704 partitions the raster media into blocks and sub-blocks. The block condition checking component 706 checks whether a block meets Condition 1 and Condition 2 for encoding. The data extraction component 708 decodes the hidden data (e.g., watermark) and restores the original delta coefficients.

In some embodiments, an authentication component 714 is utilized to verify the authenticity of the raster media. The authentication component 714 attempts to match the extracted watermark to a known watermark. The known watermark can be sent to the decoder out-of-band for matching or the same watermark pattern can be used for multiple raster images. For example, a plurality of watermark can be shared between the encoder and decoder and periodically (e.g., hourly, daily) changed. The authenticity component 714 can indicate the authenticity and as result other actions can be performed. For example, if the authenticity is not confirmed, the raster image can be displayed with a warning.

Watermark extraction is performed by checking the received image with condition C1 and condition C2 using the same set of V_{C}, Nₘᵢₙ, W_{seq1} and W_{seq2}. These parameters can be transmitted as side information, in-band or out-of-band, with the encoded raster media. In other embodiments, some or all of these values are predefined and shared among the encoder and decoder. Because of the number of “1”s and “−1”s in the watermark sequences are the same, Int_{S} is preserved after watermark embedding if there is no attack and the mathematical proof follows:

$$\begin{matrix}{Int}_{S} = \frac{1}{{S}_{X} {S}_{y}} {\sum }_{i = 1}^{{S}_{X}} {\sum }_{j = 1}^{{S}_{Y}} Q ( α + i , β + j ) \\ = \frac{1}{{S}_{X} {S}_{y}} {\sum }_{i = 1}^{{S}_{X}} {\sum }_{j = 1}^{{S}_{Y}} ( Q ( α + i , β + j - 1 ) + {D}^{′} ( α + i , β + j ) ) \\ = \frac{1}{{S}_{X} {S}_{y}} {\sum }_{i = 1}^{{S}_{X}} {\sum }_{j = 1}^{{S}_{Y}} ( Q ( α + i , β + j - 1 ) + D ( α + i , β + j ) + \\ Δ {W}_{seq} ( i , j ) ) ) \\ = \frac{1}{{S}_{X} {S}_{y}} {\sum }_{i = 1}^{{S}_{X}} {\sum }_{j = 1}^{{S}_{Y}} ( Q ( α + i , β + j - 1 ) + D ( α + i , β + j ) ) ∵ \\ {\sum }_{x = 1}^{{S}_{X}} {\sum }_{y = 1}^{{S}_{Y}} {W}_{seq} ( i , j ) = 0 \\ = \frac{1}{{S}_{X} {S}_{y}} {\sum }_{i = 1}^{{S}_{X}} {\sum }_{j = 1}^{{S}_{Y}} P ( α + i , β + j )\end{matrix}$$

α and β are the starting index of sub-block, S

For Condition 2(C2), because of (R2), <S′, V_{C}>=<S, V_{C}>:

$$\begin{matrix}< {S}^{′} , {V}_{C} >= < S + Δ W , {V}_{C} > \\ = < S , {V}_{C} > + < Δ W , {V}_{C} > \\ = < S , {V}_{C} >\end{matrix}$$

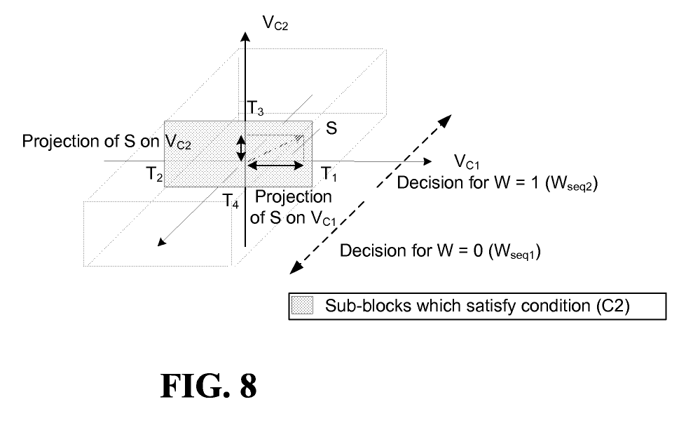

For NSet, as there is no change, the results of condition 1 and 2 (C1-2) will be the same as when performing watermark encoding. The watermark bit decision for a sub-block is shown in FIG. 8. For the blocks belonging to SSet, each block S is an inner product or correlation with W_{seq1} and W_{seq2}. The result of <S′, W_{seq}> with two watermark sequences are computed. The bit decision is shown as follows:

$$W = \{ \begin{matrix}0 & if < {W}_{seq 1} , {S}^{′} >> < {W}_{seq 2} , {S}^{′} > \\ 1 & if < {W}_{seq 1} , {S}^{′} > \leq < {W}_{seq 2} , {S}^{′} >\end{matrix} \qquad ( Equation 6 )$$

The extracted watermark bit of a block, B, is based on the voting of all the sub-blocks' decoding results. As there are more than Nₘᵢₙ sub-blocks that are “unbiased” to the watermark sequences in each block, the watermark can be decoded accurately using voting.

The inner product can be thought of as a projection. By projecting the sub-block, S, in delta domain on the V_{C}, the watermark encoded in each sub-block can be determined. The projection is shown in FIG. 8.

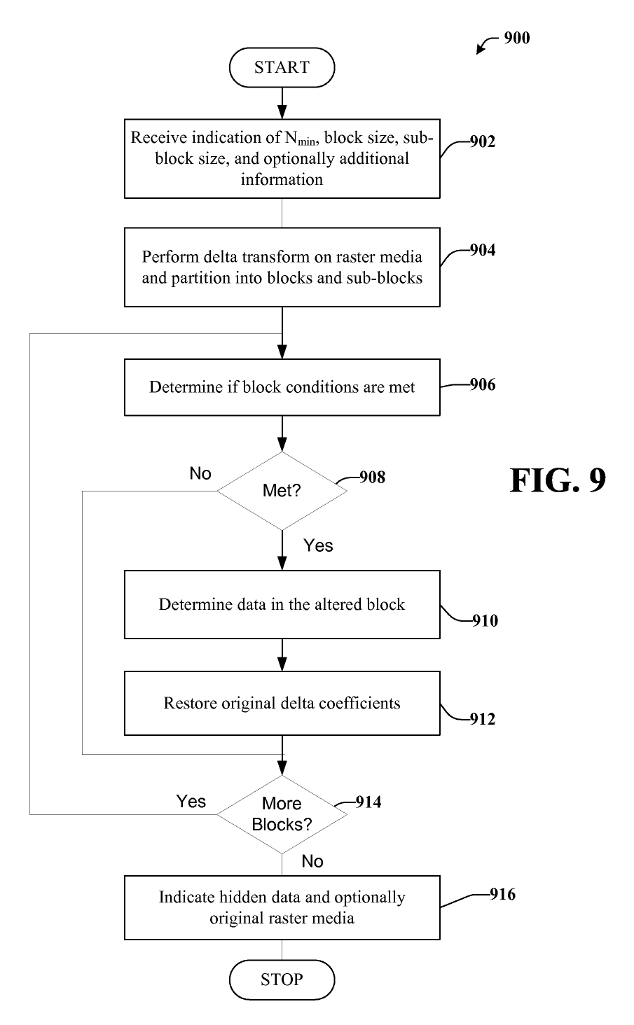

Referring to FIG. 9, an example method 900 for decoding the hidden data in raster media according to one embodiment is illustrated. At 902, an indication is received of Nₘᵢₙ, block size, sub-block size, V_{C}, W_{seq1} and W_{seq2} At 904, delta transform is performed on the encoded raster media and then at least a portion of the raster media is portioned into blocks and sub-blocks. At 906, it is determined if block conditions are met for the selected block. For example, the exemplary method illustrated in FIG. 5 can be utilized; however, the block conditions checking should be the same as the block checking performed by the encoder. When proceeding from 904, the first block is selected and the next block is selected when returning from 914. At 908, the data is determined and extracted. At 912, the original delta coefficients are restored. At 914, if there are more blocks to process, the next block is selected and determined if block conditions are met at 906. If there are no more blocks, the hidden data is indicated and optionally the original raster media after inverse delta transform is performed.

The upper bound of the payload of the technique depends on block size, image size and image properties. The upper bound of payload is the total number of blocks, B, in the image. The lower bound of PSNR depends on the watermark strength, Δ. As the elements are modified in delta domain, half of the pixels of each sub-block will not be changed. The mathematical proof is shown as follows:

$$\begin{matrix}Q ( x , y ) = Q ( x , y - 1 ) + {D}^{′} ( x , y ) \\ = Q ( α + i , β + j - 1 ) + D ( α + i , β + j ) + Δ {W}_{seq} ( i , j ) \\ = \{ \begin{matrix}Q ( α + i , β + j - 1 ) + D ( α + i , β + j ) + Δ {W}_{seq} ( i , j ) & if j is odd \\ \begin{matrix}Q ( α + i , β + j - 2 ) + D ( α + i , β + j - 1 ) + \\ D ( α + i , β + j ) + Δ {W}_{seq} ( i , j - 1 ) + Δ {W}_{seq} ( i , j )\end{matrix} & if j is even\end{matrix}\end{matrix}$$

$$\begin{matrix}\begin{matrix}∵ {W}_{seq} is in \\ checkerboard \\ pattern\end{matrix} = \{ \begin{matrix}Q ( α + i , β + j - 1 ) + D ( α + i , β + j ) + Δ {W}_{seq} ( i , j ) & if j is odd \\ Q ( α + i , β + j - 2 ) + D ( α + i , β + j - 1 ) + D ( a + i , β + j ) & if j is even\end{matrix} \\ = \{ \begin{matrix}P ( α + i , β + j ) + Δ {W}_{seq} ( i , j ) & if j is odd \\ P ( α + i , β + j ) & if j is even\end{matrix}\end{matrix}$$

where α and β are the starting index of sub-block, S

Thus, when the sub-block index, j, is even (which is the even-row of each sub-block), the watermarked pixel value is the same as the original pixel value. As a result, half of the pixels in the SSet remain unchanged, and the MSE reduction of SSet is:

$$MSE reduction = \frac{1}{2} Δ \times Δ$$

For the blocks of NSet, all the pixels remain unchanged. As a result, the general expression of a lower bound of PSNR is:

$$PSNR \geq 10 log \frac{255 \times 255}{0.5 Δ \times Δ}$$

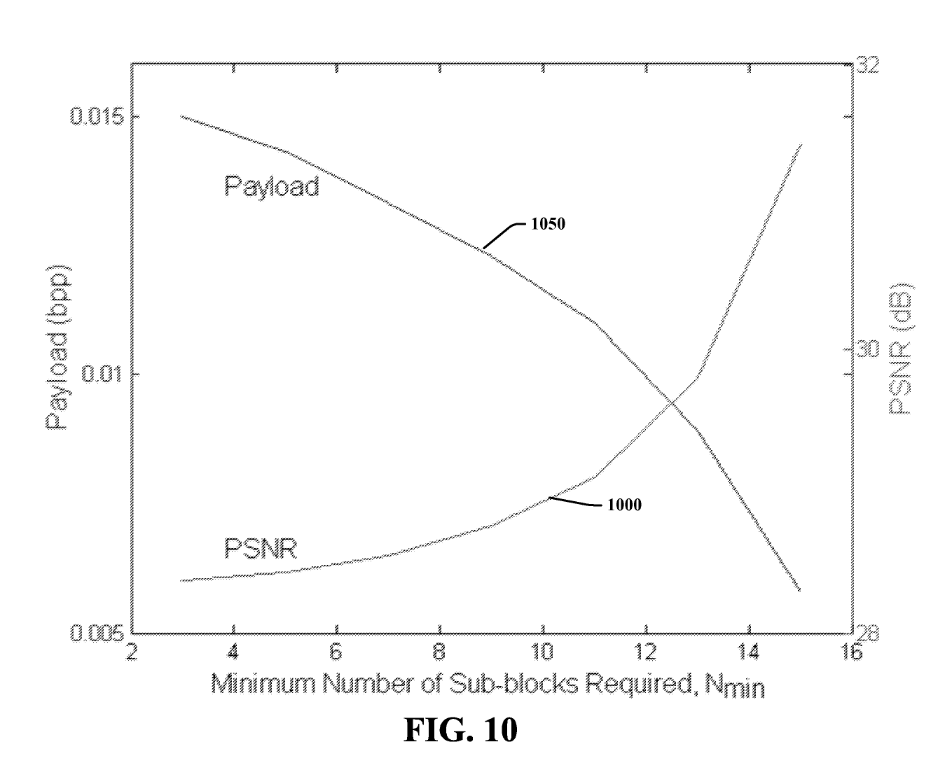

Referring to FIG. 10, the relationship between the payload (bits per pixel (bpp)) and the peak signal to noise ratio (PSNR) (in dB) to Nₘᵢₙ for the Lena image (FIG. 6A) using the technique is illustrated. In particular, curve 1000 illustrates the relationship of PSNR to Nₘᵢₙ and curve 1050 illustrates the relationship of payload in bits per pixel to Nₘᵢₙ. As the results illustrate, the larger the Nₘᵢₙ is, the smaller the payload is, but the higher the PSNR is.

As stated previously, the technique can be extended to withstand a number of attacks. For example, since delta domain transform is local, a crop attack can be overcome if side information is supplied so that the location of remaining blocks in a cropped image can be determined. In addition, the technique can also be extended to withstand a JPEG attack, where an image containing hidden data is encoded into JPEG format to try and render the hidden data undetectable. By storing a location map of the hidden data, the hidden data can still be extracted from a possibly corrupted image with the help of the location map.

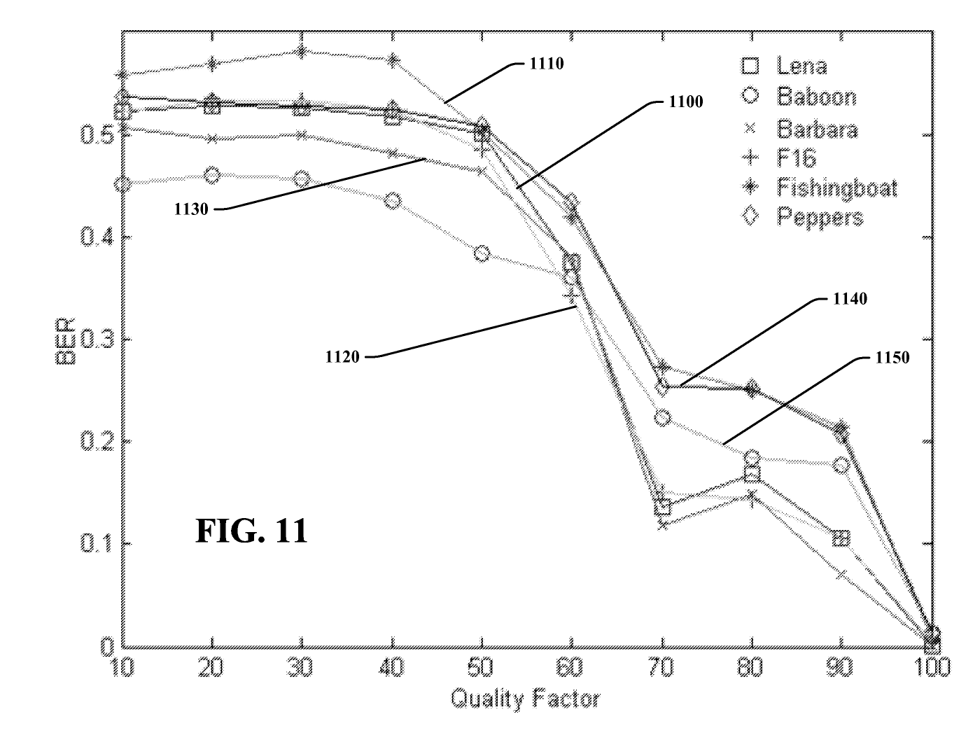

Referring to FIG. 11, the performance of test images against JPEG attack is depicted. Curves of the bit error rate (BER) versus the quality factor used in JPEG encoding for various standard images from the USC-SIPI Image Database are depicted. In particular, curves (1100, 1110, 1120, 1130, 1140, 1150) are depicted for Lena, Fishingboat, F16, Barbara, Peppers and Baboon, respectively. As shown from the results, when the quality factor is greater than 70, the BER is less than 0.35, which means the watermark or other hidden data is still detectable. For some images, such as F16, the technique can withstand a quality factor of 60.

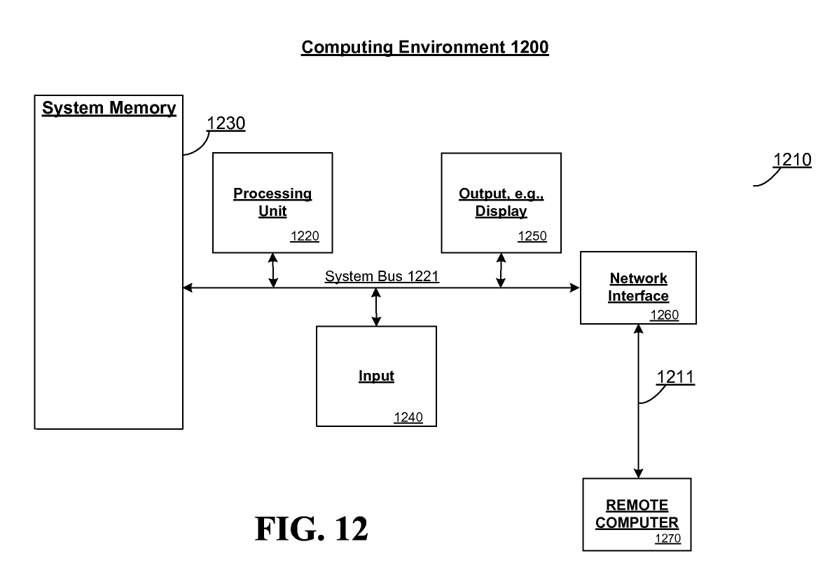

Turning now to FIG. 12, an exemplary non-limiting computing system or operating environment in which the present invention may be implemented is illustrated. Handheld, portable and other computing devices and computing objects of all kinds are contemplated for use in connection with the present invention, i.e., anywhere that visual media is presented, distributed from, or forensically analyzed. Accordingly, the below general purpose remote computer described below in FIG. 12 is but one example of a computing system in which the present invention may be implemented.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 12 thus illustrates an example of a suitable computing system environment 1200a in which the invention may be implemented, although as made clear above, the computing system environment 1200a is only one example of a suitable computing environment for a media device and is not intended to suggest any limitation as to the scope of use or functionality of the invention. Neither should the computing environment 1200a be interpreted as having any dependency or requirement relating to any one or combination of components illustrated in the exemplary operating environment 1200a.

With reference to FIG. 12, an example of a remote device for implementing the invention includes a general purpose computing device in the form of a computer 1210. Components of computer 1210 can include, but are not limited to, a processing unit 1220, a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures.

Computer 1210 typically includes a variety of computer readable media. Computer readable media can be any available media that can be accessed by computer 1210. By way of example, and not limitation, computer readable media may comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media typically embodies computer readable instructions, data structures, program modules or other data in a modulated data signal such as a carrier wave or other transport mechanism and includes any information delivery media.

The system memory 1230 can include computer storage media in the form of volatile and/or nonvolatile memory such as read only memory (ROM) and/or random access memory (RAM). A basic input/output system (BIOS), containing the basic routines that help to transfer information between elements within computer 1210a, such as during start-up, may be stored in memory 1230. Memory 1230 typically also contains data and/or program modules that are immediately accessible to and/or presently being operated on by processing unit 1220. By way of example, and not limitation, memory 1230 can also include an operating system, application programs, other program modules, and program data.

The computer 1210 can also include other removable/non-removable, volatile/nonvolatile computer storage media. For example, computer 1210 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1221 through a non-removable memory interface such as an interface, and a magnetic disk drive or optical disk drive is typically connected to the system bus 1221 by a removable memory interface, such as an interface.

A user may enter commands and information into the computer 1210 through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1220 through user input 1240 and associated interface(s) that are coupled to the system bus 1221, but can be connected by other interface and bus structures, such as a parallel port, game port or a universal serial bus (USB). A graphics subsystem may also be connected to the system bus 1221. A monitor or other type of display device is also connected to the system bus 1221 via an interface, such as output interface 1250, which can in turn communicate with video memory. In addition to a monitor, computers may also include other peripheral output devices such as speakers and a printer, which may be connected through output interface 1250.

The computer 1210 can operate in a networked or distributed environment using logical connections to one or more other remote computers, such as remote computer 1210, which can in turn have media capabilities different from device 1210. The remote computer 1270 can be a personal computer, a server, a router, a network PC, a peer device or other common network node, or any other remote media consumption or transmission device, and may include any or all of the elements described above relative to the computer 1210. The logical connections depicted in FIG. 12 include a network 1212, such local area network (LAN) or a wide area network (WAN), but may also include other networks/buses. Such networking environments are commonplace in homes, offices, enterprise-wide computer networks, intranets and the Internet.

When used in a LAN networking environment, the computer 1210 is connected to the LAN 1211 through a network interface or adapter. When used in a WAN networking environment, the computer 1210 typically includes a communications component, such as a modem, or other means for establishing communications over the WAN, such as the Internet. A communications component, such as a modem, which may be internal or external, may be connected to the system bus 1221 via the user input interface of input 1240, or other appropriate mechanism. In a networked environment, program modules depicted relative to the computer 1210, or portions thereof, may be stored in a remote memory storage device. It will be appreciated that the network connections shown and described are exemplary and other means of establishing a communications link between the computers may be used.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the invention described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

Furthermore, the invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments. Furthermore, as will be appreciated various portions of the disclosed systems above and methods below may include or consist of sub-components, processes, means, methodologies, or mechanisms.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A method of data hiding for raster images, comprising:
transforming at least some pixels of an original raster media into delta domain coefficients;
dividing at least a portion of the raster media into multiple blocks of a predetermined size; and
for each of the multiple blocks,
determining if block conditions are met for the block according to predetermined rules for encoding one or more bits of hidden data; and
if block conditions are met, encoding one or more bits of hidden data into the block.

2. The method of claim 1, wherein the encoding includes encoding at least one digital watermark.

3. The method of claim 1, further comprising subdividing each of the multiple blocks into multiple sub-blocks, the sub-blocks having a predetermined size, the predetermined size having an even length and even width, and wherein the determining if block conditions are met for the block includes determining if a number of unbiased sub-blocks within a block exceeds a predefined number.

4. The method of claim 1, further comprising transforming the delta domain coefficients back to pixel values.

5. The method of claim 1, wherein the determining if block conditions are met includes determining if the block is a region of low variance.

6. The method of claim 1, wherein the encoding of one or more bits of hidden data into the block includes encoding at least two hidden bits per block.

7. The method of claim 1, wherein the encoding of one or more bits of hidden data into the block includes using Mean-Square Error (MSE) reduction to embed the one or more bits of hidden data in the delta domain.

8. The method of claim 1, wherein the at least some pixels of the original raster image includes all pixels of the original raster image except for the first row of the original raster image.

9. The method of claim 1, further comprising receiving an indication of the predetermined block size.

10. The method of claim 1, further comprising generating a location map, the location map indicating the blocks where one or more bots of hidden data were encoded.

11. A computer-readable medium containing computer-executable operations for performing the method of claim 1.

12. A digital watermarking system comprising:
a delta transform component that transform at least some pixels into delta domain coefficients;
a partitioning component that partitions the domain coefficients into multiple blocks;
a block condition component that determines if a block meets predefined conditions for encoding one or more watermark bits;
a data hiding component that encodes one or more watermark bits;
a checkerboard pattern creation component that determines multiple watermark sequences and a set of condition matrices; and
an inverse delta transform component that transforms delta domain coefficients into pixel values.

13. The system of claim 12, further comprising a data extraction component that decodes the watermark.

14. The system of claim 13, further comprising an authentication component that compares the decoded watermark from the data extraction component to a predetermined watermark.

15. A method of recovering a digital watermark in a raster image containing an encoded watermark, comprising:
transforming at least some pixels of a raster image into delta domain coefficients;
dividing the image coefficients into multiple blocks;
for each of the multiple blocks,
determining if block conditions are met;
if the block conditions are met, decoding one or more watermark bits from the block; and
indicating a watermark comprised of the decoded watermark bits.

16. The method of claim 15, further comprising:
for each block, if the block conditions are met, restoring delta coefficients back to original values;
transforming the original delta domain coefficients to pixel values; and
indicating an raster image comprising the pixel values.

17. The method of claim 16, further comprising receiving a location map, the location map indicating the blocks where one or more watermark bits are encoded.

18. The method of claim 15, further comprising:
indicating whether the at least one extracted watermark bit matches at least one predetermined watermark bit.

19. A decoding apparatus comprising means for performing the method of claim 15.

20. A computer-readable medium containing computer-executable operations for performing the method of claim 15.
